(19) United States
(12) Patent Application Publication
(10) Pub. No.: US 2024/0404265 A1
(43) Pub. Date: Dec. 5, 2024

(54) COMPUTATION APPARATUS, COMPUTATION METHOD, AND NON-TRANSITORY COMPUTER-READABLE STORAGE MEDIUM

(71) Applicant: CANON KABUSHIKI KAISHA, Tokyo (JP)

(72) Inventors: Kazuhiro MIMA, Tokyo (JP); Motoki YOSHINAGA, Kanagawa (JP)

(21) Appl. No.: 18/670,763

(22) Filed: May 22, 2024

(30) Foreign Application Priority Data
Jun. 1, 2023 (JP) 2023-091032

(51) Int. Cl. G06V 10/82

(52) U.S. Cl. CPC G06V 10/82

(57) ABSTRACT

A computation apparatus, comprises a first processing unit configured to obtain a first feature by executing computation of a neural network with use of a first coefficient that is not to be updated in online learning of the neural network, a second processing unit configured to obtain a second feature by executing the computation of the neural network with use of the first feature and a second coefficient that is to be updated in the online learning, and an update unit configured to update the second coefficient by executing the online learning with use of the second coefficient and a second feature that has been obtained by the second processing unit in a past. Processing of the first processing unit and processing of the update unit are executed in parallel.

### BACKGROUND OF THE INVENTION

### Field of the Invention

The present invention relates to a technique to execute computation of a neural network and online learning.

### Description of the Related Art

There is object detection processing that uses a neural network as a method of detecting an object in an image. Also, there is a system that requires object tracking, which is a technique to keep detecting an object that has been detected in an image (frame) of a certain time included among moving images while the object is present in the moving images thereafter. The features of the tracking target objects that have been detected are slightly different from one another due to the shooting environments or the objects themselves, even if the types of the objects are the same. The feature differences may trigger a reduction in the accuracy of object tracking.

Online learning is used to improve the accuracy of object tracking. “Discriminative and Robust Online Learning for Siamese Visual Tracking”, J. Zhou et al., Vol 34 No 07: AAAI-20 Technical Tracks 7 (2020) discloses an object racking method that uses a neural network. Online learning is processing for updating a part of weight coefficients of a neural network using an inference result from the neural network.

Meanwhile, an embedded image capturing device such as a digital camera needs to realize necessary processing with a limited computation performance and memory capacity. A computation apparatus disclosed in Japanese Patent Laid-Open No. 2021-9566 efficiently executes neural network computation and subsequent post-processing with use of a convolution operation unit and a central processing unit (CPU). Also in a case where online learning processing has been incorporated in addition to the foregoing, a computation apparatus is desired that can execute the online learning processing while suppressing a decline in the performance of neural network computation.

In online learning, an inference result is used to update weight coefficients of a neural network. Therefore, in the online learning, after the inference result has been obtained, it is necessary to execute processing for updating the weight coefficients of the neural network using this result. In this case, a processing time period per frame is a sum total of an inference time period and a processing time period of the online learning. When the online learning is applied, the processing time period per frame increases and the frame rate of object tracking worsens compared to when the online learning is not applied. Therefore, there is a demand for a computation technique that enables the execution of inference and online learning while suppressing an increase in the processing time period.

### SUMMARY OF THE INVENTION

The present invention provides a technique that enables parallel execution of computation of a neural network and online learning.

According to the first aspect of the present disclosure, there is provided a computation apparatus, comprising: a first processing unit configured to obtain a first feature by executing computation of a neural network with use of a first coefficient that is not to be updated in online learning of the neural network; a second processing unit configured to obtain a second feature by executing the computation of the neural network with use of the first feature and a second coefficient that is to be updated in the online learning; and an update unit configured to update the second coefficient by executing the online learning with use of the second coefficient and a second feature that has been obtained by the second processing unit in a past, wherein processing of the first processing unit and processing of the update unit are executed in parallel.

According to the second aspect of the present disclosure, there is provided a computation apparatus, comprising: a first processing unit configured to obtain a first feature by executing computation of a neural network with use of a first coefficient that is not to be updated in online learning of the neural network; a second processing unit configured to obtain a second feature by executing the computation of the neural network with use of the first feature and a second coefficient that is to be updated in the online learning; a third processing unit configured to obtain a third feature by executing the computation of the neural network with use of the second feature and a third coefficient of the neural network; and an update unit configured to update the second coefficient by executing the online learning based on the second coefficient and the first feature, wherein processing of the third processing unit and processing of the update unit are executed in parallel.

According to the third aspect of the present disclosure, there is provided a computation method implemented by a computation apparatus, comprising: obtaining a first feature by executing computation of a neural network with use of a first coefficient that is not to be updated in online learning of the neural network; obtaining a second feature by executing the computation of the neural network with use of the first feature and a second coefficient that is to be updated in the online learning; and updating the second coefficient by executing the online learning with use of the second coefficient and a second feature that has been obtained in a past, wherein the obtainment of the first feature and the updating are executed in parallel.

According to the fourth aspect of the present disclosure, there is provided a computation method implemented by a computation apparatus, comprising: obtaining a first feature by executing computation of a neural network with use of a first coefficient that is not to be updated in online learning of the neural network; obtaining a second feature by executing the computation of the neural network with use of the first feature and a second coefficient that is to be updated in the online learning; obtaining a third feature by executing the computation of the neural network with use of the second feature and a third coefficient of the neural network; and updating the second coefficient by executing the online learning based on the second coefficient and the first feature, wherein the obtainment of the third feature and the updating are executed in parallel.

According to the fifth aspect of the present disclosure, there is provided a non-transitory computer-readable storage medium storing a computer program that causes a computer to function as: a first processing unit configured to obtain a first feature by executing computation of a neural network with use of a first coefficient that is not to be updated in online learning of the neural network; a second processing unit configured to obtain a second feature by executing the computation of the neural network with use of the first feature and a second coefficient that is to be updated in the online learning; and an update unit configured to update the second coefficient by executing the online learning with use of the second coefficient and a second feature that has been obtained by the second processing unit in a past, wherein processing of the first processing unit and processing of the update unit are executed in parallel.

According to the sixth aspect of the present disclosure, there is provided a non-transitory computer-readable storage medium storing a computer program that causes a computer to function as: a first processing unit configured to obtain a first feature by executing computation of a neural network with use of a first coefficient that is not to be updated in online learning of the neural network; a second processing unit configured to obtain a second feature by executing the computation of the neural network with use of the first feature and a second coefficient that is to be updated in the online learning; a third processing unit configured to obtain a third feature by executing the computation of the neural network with use of the second feature and a third coefficient of the neural network; and an update unit configured to update the second coefficient by executing the online learning based on the second coefficient and the first feature, wherein the obtainment of the third feature and the updating are executed in parallel.

Further features of the present invention will become apparent from the following description of exemplary embodiments with reference to the attached drawings.

### BRIEF DESCRIPTION OF THE DRAWINGS

FIG. 1 is a block diagram showing an outline of computation and online learning of a neural network.

FIG. 2 is a block diagram showing an exemplary configuration of a conventional computation apparatus for executing a neural network task and an online learning task.

FIG. 3 is a diagram showing examples of operations of each of a CPU 203 and a CNN processing unit 201 for a case where a neural network task and an online learning task are executed.

FIG. 4 is a block diagram showing an exemplary configuration of a computation apparatus.

FIG. 5 is a block diagram showing the structures of processing executed by a CNN processing unit 401 and a CPU 403.

FIG. 6 is a diagram showing data stored in a memory 402 and a memory 406.

FIG. 7A is a diagram illustrating a neural network task and an online learning task executed by the computation apparatus.

FIG. 7B is a diagram illustrating a neural network task and an online learning task executed by the computation apparatus.

FIG. 8A is a flowchart showing the operations of the CPU 403.

FIG. 8B is a flowchart showing the operations of the CPU 403.

FIG. 9 is a block diagram showing the structures of processing executed by a CNN processing unit 401 and a CPU 403.

FIG. 10 is a diagram showing data stored in the memory 402 and the memory 406.

FIG. 11 is a diagram illustrating a neural network task and an online learning task executed by the computation apparatus.

FIG. 12 is a block diagram showing the structures of processing executed by the CNN processing unit 401 and the CPU 403.

FIG. 13 is a diagram showing data stored in the memory 402 and the memory 406.

FIG. 14 is a diagram illustrating a neural network task and an online learning task executed by the computation apparatus.

FIG. 15A is a flowchart showing the operations of the CPU 403.

FIG. 15B is a flowchart showing the operations of the CPU 403.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

To clarify the essential points of the present embodiment, a method of executing computation of a neural network and online learning on a general computation apparatus will be described, and then the present embodiment will be described.

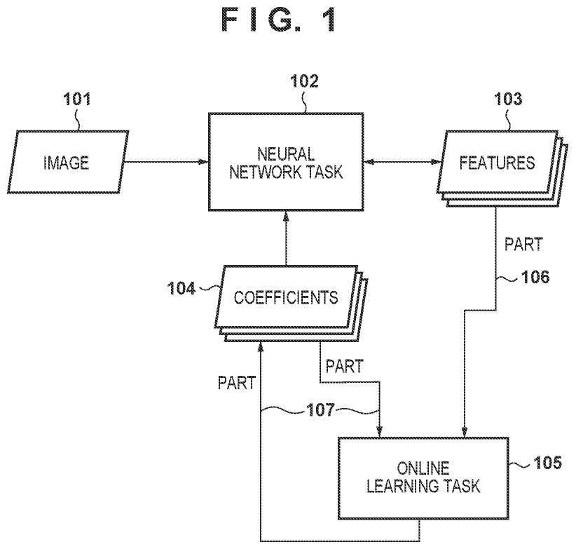

A block diagram of FIG. 1 shows an outline of computation and online learning of a neural network. In a neural network task 102, features 103 are generated by executing computation of a neural network (neural network computation) with use of an image 101 and coefficients 104 of the neural network, or new features 103 are generated by executing neural network computation with use of coefficients 104 and features 103 that have been generated through the previous neural network computation. For example, a hierarchical neural network such as a convolutional neural network (hereinafter referred to as CNN) can be applied as the neural network.

On the other hand, in an online learning task 105, with use of a part 106 of features 103 that were generated in the neural network task 102, a part 107 of coefficients 104 used in the generation of such features is updated.

The online learning task 105 uses the coefficients 104 that are referred to by the neural network task 102, and the features 103 generated by the neural network task 102. The online learning task 105 needs to be executed after the completion of the neural network task 102.

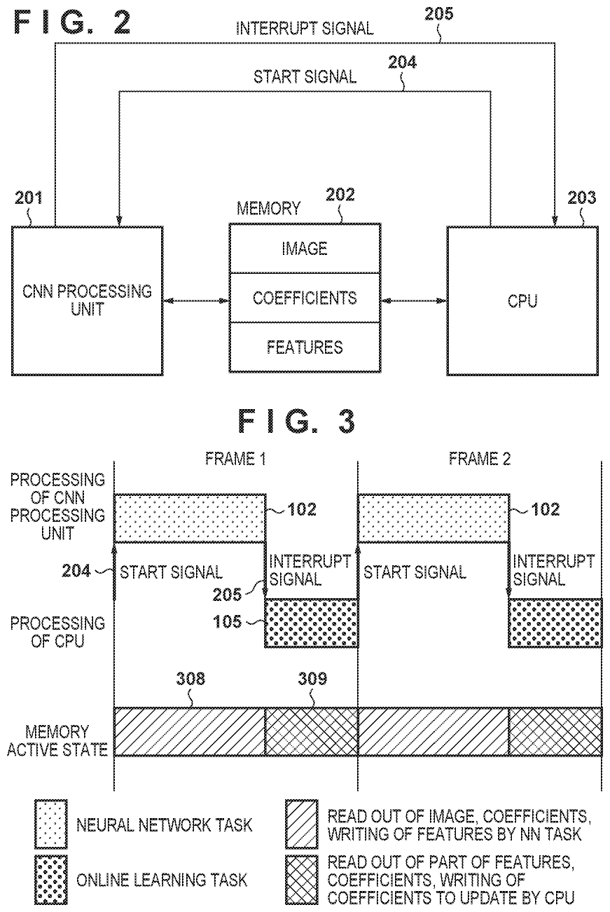

An exemplary configuration of a conventional computation apparatus for executing a neural network task and an online learning task will be described using a block diagram of FIG. 2. A memory 202 stores images, coefficients, and features that are used in a neural network task and an online learning task.

A CNN processing unit 201 reads out an image and coefficients from the memory 202, generates features by executing a convolution operation using the image and the coefficients that have been read out, and stores the generated features into the memory 202.

A CPU 203 reads out learning target coefficients and features related thereto from the memory 202, updates the coefficients by executing online learning using the coefficients and features that have been read out, and stores the updated coefficients into the memory 202.

The memory 202 is a single-port memory that accepts one access request at a time. An access to the memory 202 is transmitted to the memory 202 by a non-illustrated selection function selecting an access request of the CNN processing unit 201 or the CPU 203.

The CPU 203 notifies the CNN processing unit 201 of a start signal 204 that indicates a start of operations of the CNN processing unit 201. The start signal 204 is generated as a result of writing a value indicating the start from the CPU 203 to a start control register connected to a non-illustrated system bus. Upon receiving the notification of the start signal 204, the CNN processing unit 201 executes a neural network task 102. Upon completion of the neural network task 102, the CNN processing unit 201 notifies the CPU 203 of an interrupt signal 205 indicating the completion of the neural network task 102.

Upon receiving the notification of the interrupt signal 205, the CPU 203 executes an online learning task 105. Then, upon completion of the online learning task 105, the CPU 203 notifies the CNN processing unit 201 of the aforementioned start signal 204.

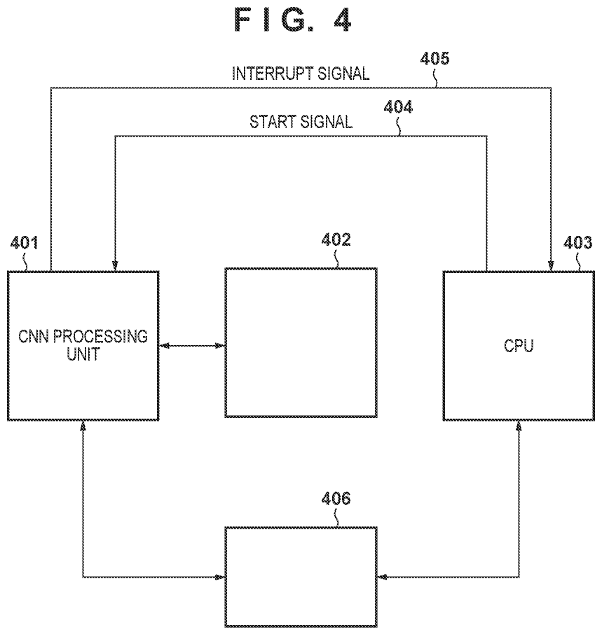

As described above, the interrupt signal 205 and the start signal 204 are used to perform control for coordinating processing timings between the CPU 203 and the CNN processing unit 201. Next, with use of FIG. 3, a description is given of the execution timings of each of the CNN processing unit 201 and the CPU 203 and a memory active state, which is equivalent to an access to the memory 202, in the conventional computation apparatus described above.

FIG. 3 shows examples of operations of each of the CPU 203 and the CNN processing unit 201 for a case where a neural network task and an online learning task are executed with respect to each of a frame 1 and a frame 2 that succeeds the frame 1. A similar neural network task and online learning task are executed with respect to both of the frame 1 and the frame 2.

The CPU 203 notifies the CNN processing unit 201 of a start signal 204 indicating a start of operations of the CNN processing unit 201. Upon detecting the start signal 204, the CNN processing unit 201 starts to execute a neural network task 102 for the frame 1. A memory active state 308 during the execution of the neural network task 102 includes readout of an image 101 (frame 1) and the coefficients 104 necessary for the execution of the neural network task 102 from the memory 202, and writing of features 103 generated through the execution of the neural network task 102 to the memory 202. Upon completion of the neural network task 102, the CNN processing unit 201 notifies the CPU 203 of an interrupt signal 205. Upon detecting the interrupt signal 205, the CPU 203 starts to execute an online learning task 105 for the frame 1. A memory active state 309 during the execution of the online learning task 105 includes readout of a part 106 and a part 107 that are necessary for the execution of the online learning task 105 from the memory 202, and writing of the part 107 that has been updated through the online learning task 105 to the memory 202. Upon completion of the online learning task 105, the CPU 203 notifies the CNN processing unit 201 of a start signal. Upon detecting the start signal, the CNN processing unit 201 starts to execute a neural network task 102 for the frame 2. The neural network task 102 for the frame 2 uses the coefficients that have been updated in the online learning task 105 for the frame 1.

As a result of updating the coefficients used in the neural network task through online learning, an improvement in the inference accuracy is expected. However, in the case of the method of FIG. 3 in which the online learning task is executed after the execution of the neural network task, a processing time period per frame is increased by a processing time period of online learning, which gives rise to a possibility of causing a reduction in the frame rate.

In order to suppress the reduction in the frame rate, it is possible to increase the operation frequency of the computation apparatus. However, an increase in the operation frequency of the computation apparatus leads to an increase in consumed power; in this case, there is a concern that an operating time period is shortened in the case of a battery-driven embedded device (e.g., an image capturing device).

In the present embodiment, a processing time period per frame is suppressed by executing a neural network task and an online learning task in parallel by making the tasks partially overlap. However, if the neural network task and the online learning task are executed in parallel by making the tasks partially overlap with use of the general computation apparatus that has been described thus far, the following problem will arise. First, an access to the memory 202 from the CNN processing unit 201 that processes the neural network task and an access thereto from the CPU 203 that executes the online learning task may occur simultaneously. As the memory 202 has a single-port configuration, it is necessary to process one access and cause another access to stand by through a mediation function. The presence of such a standby time period may interrupt the parallel executions by the CNN processing unit 201 and the CPU 203. One of the possible methods of solving this problem is to change the memory 202 from a single-port memory to a dual-port memory with access ports that are respectively dedicated to the CNN processing unit 201 and the CPU 203. In this way, the CNN processing unit 201 and the CPU 203 can access the memory 202 simultaneously, and thus the standby time period attributed to simultaneous accesses can be suppressed. However, in the online learning task, it is necessary to read out features that are obtained through the neural network task for the same frame from the memory 202 and update coefficients. As such, with respect to data that is shared between a plurality of processing units such as the CNN processing unit 201 and the CPU 203, exclusive control needs to be performed with regard to a data access. In this exclusive control, software executed by the CPU 203 and dedicated hardware may perform management; the exclusive control can possibly increase a processing load of the CPU 203 and hardware resources.

As has been described thus far, it is possible to sequentially execute the neural network task and the online learning task with use of a general computation apparatus, but it is difficult to execute them in parallel. In order to execute the neural network task and the online learning task in parallel, it is necessary to devise a memory configuration and a data arrangement for suppressing a memory access conflict and a method of controlling the execution timings of the online learning task.

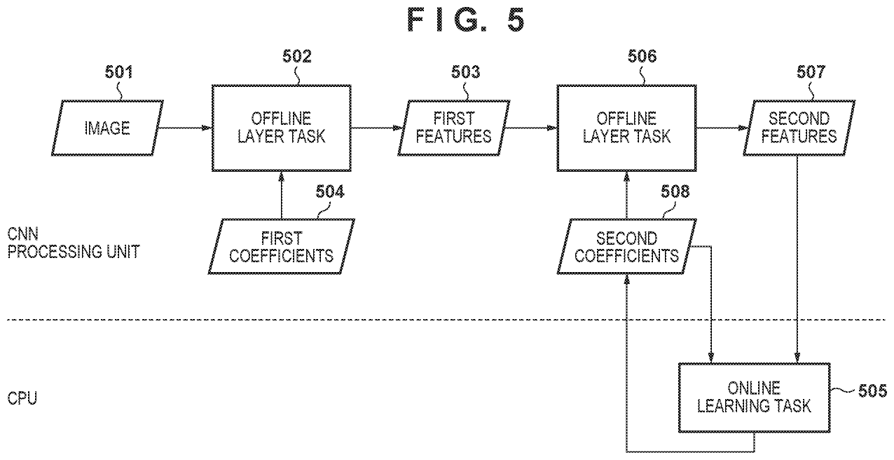

An exemplary configuration of a computation apparatus according to the present embodiment will be described using a block diagram of FIG. 4. A CNN processing unit 401 can access (read and write data from and to) both of a memory 402 and a memory 406, and executes a neural network task using data stored in the memory 402 and the memory 406.

The CPU 403 cannot access (read and write data from and to) the memory 402, can access (read and write data from and to) the memory 406, and executes an online learning task using data stored in the memory 406.

The CPU 403 notifies the CNN processing unit 401 of a start signal 404 indicating a start of operations of the CNN processing unit 401. The start signal 404 is generated as a result of writing a value indicating the start from the CPU 403 to a start control register connected to a non-illustrated system bus. Upon detecting the start signal 404, the CNN processing unit 401 starts to execute a neural network task. Upon completion of the neural network task, the CNN processing unit 401 notifies the CPU 403 of an interrupt signal 405. As described above, the interrupt signal 405 and the start signal 404 are used to perform control for coordinating processing timings between the CPU 403 and the CNN processing unit 401.

The memory 402 is a memory that the CNN processing unit 401 can possess, whereas the memory 406 is a memory that is shared by the CNN processing unit 401 and the CPU 403. The memory 402 and the memory 406 are single-port memories that accept one access request (a readout request for reading out data in the memory/a write request for writing data to the memory). An access to the memory 406 is transmitted to the memory 406 by a non-illustrated selection function selecting an access request from the CNN processing unit 401 or the CPU 403.

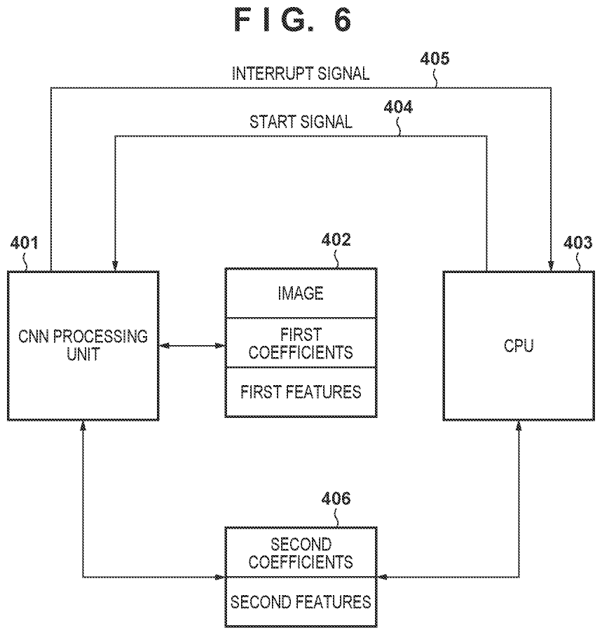

Next, the structures of processing executed by the CNN processing unit 401 and the CPU 403 will be described using a block diagram of FIG. 5. In the present embodiment, a neural network task executed by the CNN processing unit 401 is divided into two tasks, namely an offline layer task 502 and an online layer task 506, which are executed in this order.

The offline layer task 502 is “a neural network task that uses coefficients of a neural network that are not updated through an online learning task 505” in the neural network task, and is a static network computation task. In this case, the offline layer task 502 generates first features 503 by executing computation of the neural network (neural network computation) with use of an image 501 and first coefficients 504 of the neural network that are not updated through the online learning task 505.

The online layer task 506 is “a neural network task that uses coefficients of the neural network that are updated through the online learning task 505 (update targets)” in the neural network task, and is a dynamic network computation task. In this case, the online layer task 506 generates second features 507 by executing computation of the neural network (neural network computation) with use of the first features 503 generated through the offline layer task 502 and second coefficients 508 of the neural network that are updated through the online learning task 505.

Meanwhile, the CPU 403 executes the online learning task 505. In the online layer task 506, the CPU 403 updates the second coefficients 508 by using the second features 507 that have been generated by the CNN processing unit 401 executing the neural network task (the offline layer task 502 and the online layer task 506).

Dividing the neural network task into the offline layer task and the online layer task has the following two advantages. Firstly, the coefficients and the features related to the online learning task are explicitly separated from other coefficients and features. As a result, a memory access conflict can be suppressed by using a method of data arrangement in the memories, which will be described later, when causing the neural network task and the online learning task to operate partially in parallel.

Secondly, by dividing the neural network task, management can easily be performed so that the updating of the coefficients performed through the online learning task and the neural network computation that uses the updated coefficients are not executed simultaneously.

When the CPU 403 processes the online learning task while the CNN processing unit 401 is executing the offline layer task, the neural network task of the CNN processing unit 401 and the online learning task of the CPU 403 can be executed in parallel while suppressing a decline in the performance caused by a memory access conflict.

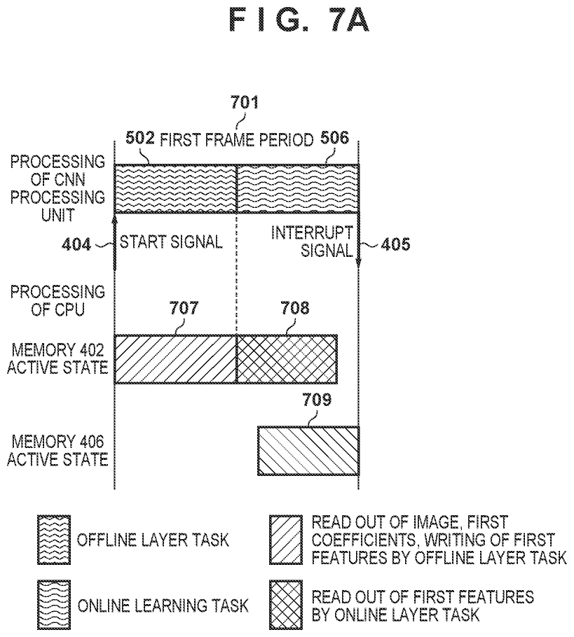

Next, data stored in the aforementioned memory 402 and memory 406 will be described using FIG. 6. The memory 406 is a memory that can be accessed by both of the CNN processing unit 401 and the CPU 403; therefore, data that is shared by the neural network task and the online learning task (the second coefficients 508 and the second features 507) is stored in the memory 406.

On the other hand, the memory 402 is a memory that the CNN processing unit 401 can possess; therefore, data that is used only by the CNN processing unit 401 (the image 501, the first coefficients 504, and the first features 503) is stored in the memory 402.

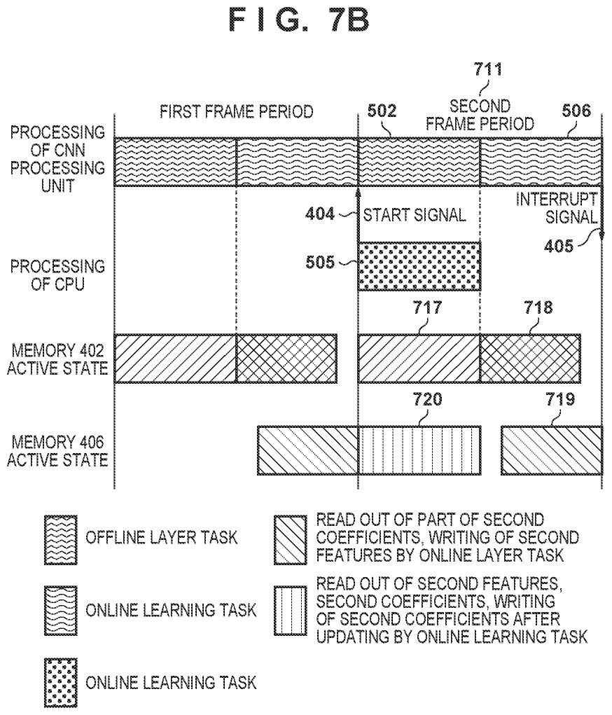

The neural network task and the online learning task that are executed by the computation apparatus according to the present embodiment in accordance with the foregoing configuration will be described using FIGS. 7A and 7B. FIG. 7A shows operation statuses of the CNN processing unit 401, the CPU 403, the memory 402, and the memory 406 during a processing period for a first frame, which is the first input image (a first frame period 701).

As shown in FIG. 7A, the CPU 403 notifies the CNN processing unit 401 of a start signal 404 at a timing to start processing with respect to the first frame, such as a timing at which the first frame has been input.

Upon detecting the start signal 404, the CNN processing unit 401 executes an offline layer task 502. In the execution of the offline layer task 502, the CNN processing unit 401 first reads out the image 501 (first frame) and the first coefficients 504 from the memory 402. Then, the CNN processing unit 401 generates the first features 503 of the first frame by executing the neural network computation with use of the first frame and the first coefficients 504 that have been read out, and stores the first features 503 of the first frame into the memory 402. An active state 707 of the memory 402 indicates a period of access to the memory 402 for readout of the first frame and the first coefficients 504 from the memory 402, and for storing of the first features 503 into the memory 402.

Upon completion of the offline layer task 502, the CNN processing unit 401 subsequently executes an online layer task 506. In the execution of the online layer task 506, the CNN processing unit 401 first reads out the first features 503 of the first frame, which have been stored into the memory 402 through the offline layer task 502, from the memory 402, and also reads out the second coefficients 508 held in the memory 406 from the memory 406. Then, the CNN processing unit 401 generates the second features 507 of the first frame by executing the neural network computation with use of the first features 503 of the first frame and the second coefficients 508, and stores the second features 507 of the first frame into the memory 406. An active state 708 of the memory 402 indicates a period of access to the memory 402 for readout of the first features 503 from the memory 402. An active state 709 of the memory 406 indicates a period of access to the memory 406 for readout of the second coefficients 508 from the memory 406, and for storing of the second features 507 into the memory 406. Upon completion of the online layer task 506, the CNN processing unit 401 notifies the CPU 403 of an interrupt signal 405.

FIG. 7B shows operation statuses of the CNN processing unit 401, the CPU 403, the memory 402, and the memory 406 during a processing period for a second frame that succeeds the first frame (a second frame period 711), which follow the neural network task for the first frame shown in FIG. 7A.

Upon receiving the aforementioned interrupt signal 405 from the CNN processing unit 401, the CPU 403 executes an online learning task 505. At this point, the second coefficients 508 and the second features 507 of the first frame (past frame) are stored in the memory 406. Therefore, in the execution of the online learning task 105, the CPU 403 reads out the second coefficients 508 and the second features 507 of the first frame from the memory 406, and updates the second coefficients 508 using the second features 507 of the first frame. Then, the CPU 403 stores the updated second coefficients 508 by overwriting the second coefficients stored in the memory 406 using the same.

Also, upon receiving the aforementioned interrupt signal 405 from the CNN processing unit 401, the CPU 403 notifies the CNN processing unit 401 of a start signal 404. Upon detecting the start signal 404 from the CPU 403, the CNN processing unit 401 executes an offline layer task 502. In the execution of the offline layer task 502, the CNN processing unit 401 reads out the image 501 (second frame) and the first coefficients 504 from the memory 402. Then, the CNN processing unit 401 generates the first features 503 of the second frame by executing the neural network computation with use of the second frame and the first coefficients 504 that have been read out, and stores the first features 503 of the second frame into the memory 402.

That is to say, in the present embodiment, the online learning task 505 of the CPU 403 and the offline layer task 502 of the CNN processing unit 401 are executed in parallel. An active state 717 of the memory 402 indicates a period of access to the memory 402 for readout of the second frame and the first coefficients 504 from the memory 402, and for storing of the first features 503 into the memory 402.

An active state 720 of the memory 406 indicates a period of access to the memory 406 for readout of the second coefficients 508 and the second features 507 of the first frame from the memory 406, and for storing of the second coefficients into the memory 406.

Upon completion of the offline layer task 502, the CNN processing unit 401 subsequently executes an online layer task 506. In the execution of the online layer task 506, the CNN processing unit 401 reads out the first features 503 of the second frame, which have been stored into the memory 402 in the offline layer task 502, from the memory 402, and also reads out the second coefficients 508 updated through the online learning task 505 from the memory 406. Then, the CNN processing unit 401 generates the second features 507 of the second frame by executing the neural network computation with use of the first features 503 and the second coefficients 508 that have been read out, and stores the second features 507 of the second frame into the memory 406.

An active state 718 of the memory 402 indicates a period of access to the memory 402 for readout of the first features 503 from the memory 402. An active state 719 of the memory 406 indicates a period of access to the memory 406 for readout of the second coefficients 508 from the memory 406, and for storing of the second features 507 of the second frame into the memory 406. Upon completion of the online layer task 506, the CNN processing unit 401 notifies the CPU 403 of an interrupt signal 405.

As described above, during a period in which the offline layer task of the CNN processing unit 401 and the online learning task of the CPU 403 are in operation in parallel, the CNN processing unit 401 accesses the memory 402, and the CPU 403 accesses the memory 406. Therefore, a memory access conflict between the CNN processing unit 401 and the CPU 403 is suppressed, and the parallel execution of an online learning task by the CPU 403 becomes possible while suppressing a decline in the performance caused by a wait for a memory access by the CNN processing unit 401.

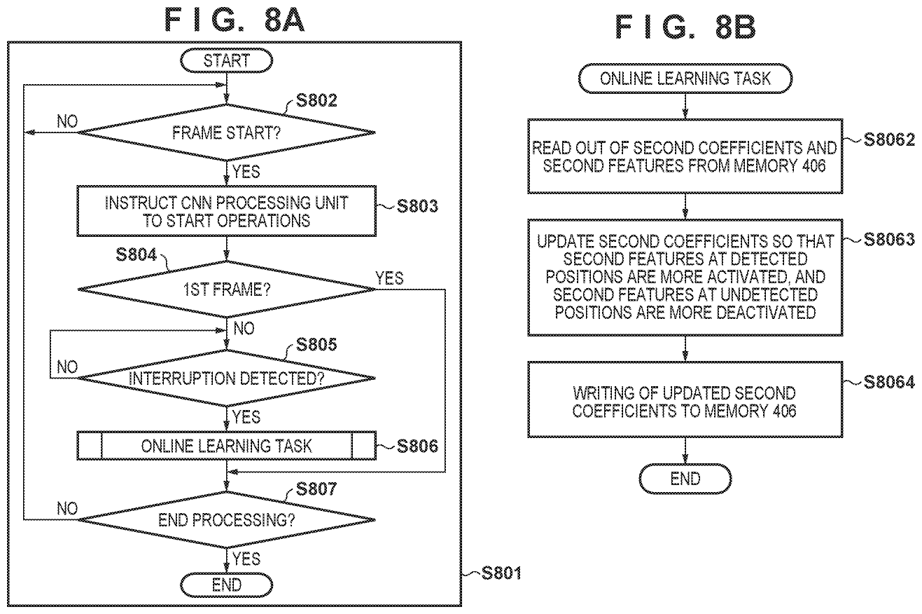

The operations of the CPU 403 are now described in line with the flowcharts of FIGS. 8A and 8B. First, step S801, which represents processing steps of main processing of the CPU 403, will be described in line with the flowchart of FIG. 8A.

In step S802, the CPU 403 determines whether a frame start condition has been satisfied. For example, the CPU 403 may determine that the “frame start condition” has been satisfied when an image (frame) targeted for the neural network task has been stored into the memory 402.

In a case where the frame start condition has been satisfied as a result of this determination, processing proceeds to step S803; in a case where the frame start condition has not been satisfied, processing stands by in step S802.

In step S803, in order to instruct the CNN processing unit 401 to start the operations, the CPU 403 notifies the CNN processing unit 401 of a start signal. Upon detecting the start signal, the CNN processing unit 401 executes an offline layer task and an online layer task as described above.

In step S804, the CPU 403 determines whether an image that is a current processing target is an image of the first frame. In a case where the image that is the current processing target is the image of the first frame as a result of this determination, processing proceeds to step S807; in a case where the image that is the current processing target is an image of the second or subsequent frame, processing proceeds to step S805.

In step S805, the CPU 403 determines whether an interrupt signal from the CNN processing unit 401 has been detected. In a case where the interrupt signal from the CNN processing unit 401 has been detected as a result of this determination, processing proceeds to step S806; in a case where the interrupt signal from the CNN processing unit 401 has not been detected, processing stands by in step S805.

In step S806, the CPU 403 executes an online learning task. The details of step S806 will be described later. In step S807, the CPU 403 determines whether a condition for ending the main processing has been satisfied. For example, the CPU 403 determines that the condition for ending the main processing has been satisfied when an ending instruction has been issued from a system of a higher level in which the computation apparatus is installed.

In a case where the condition for ending the main processing has been satisfied as a result of this determination, processing of step S801 is ended; in a case where the condition for ending the main processing has not been satisfied, processing proceeds to step S802.

Next, the details of processing in the aforementioned step S806 will be described in line with the flowchart of FIG. 8B. In step S8062, the CPU 403 reads out the second coefficients 508 and the second features 507 from the memory 406. Then, in step S8063, the CPU 403 updates the second coefficients 508 using the second features 507. More specifically, the CPU 403 updates the second coefficients 508 so that the second features 507 at detected positions of a detection target are more activated, and the second features 507 at undetected positions are more deactivated. Regarding detected positions and undetected positions, among the second features 507, the features that exceed a predetermined threshold may be determined to be detected positions, whereas the features that are equal to or smaller than the threshold may be determined to be undetected positions, or it is permissible to use detected positions obtained from the CNN processing unit 401 or another computation apparatus. Then, in step S8064, the CPU 403 stores the updated second coefficients 508 by overwriting the second coefficients 508 stored in the memory 406 using the same.

Note that the image that has been described as the second frame in the present embodiment may be an image of the third or subsequent frame; in this case, in the description of processing related to the second frame, it is sufficient to read the “first frame” as a “frame that has been input immediately before the second frame”.

### Second Embodiment

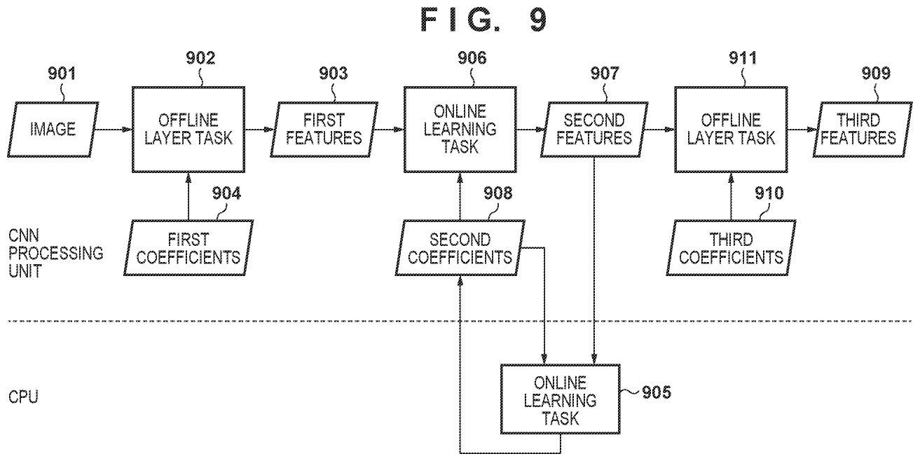

In the present embodiment, the differences from the first embodiment will be described, and it is assumed that the present embodiment is similar to the first embodiment unless specifically stated otherwise below. In the first embodiment, the neural network task is not configured in such a manner that the features generated in an online layer task are not referred to by the CNN processing unit. The present embodiment will be described in relation to parallel execution of a neural network task and an online learning task for a case where the features generated in an online layer task are referred to in a new offline layer task that immediately succeeds the same. First, the structures of processing executed by the CNN processing unit 401 and the CPU 403 will be described using a block diagram of FIG. 9.

A neural network task executed by the CNN processing unit 401 is divided into three tasks, namely an offline layer task 902, an online layer task 906, and an offline layer task 911, which are executed in this order.

The offline layer task 902 is a task similar to the offline layer task 502. The offline layer task 902 generates first features 903 by executing computation of the neural network (neural network computation) with use of an image 901 and first coefficients 904 of the neural network that are not updated through an online learning task 905.

The online layer task 906 is a task similar to the online layer task 506. The online layer task 906 generates second features 907 by executing computation of the neural network (neural network computation) with use of the first features 903 generated through the offline layer task 902 and second coefficients 908 of the neural network that are updated through the online learning task 905.

The offline layer task 911 generates third features 909 by executing computation of the neural network (neural network computation) with use of the second features 907 and third coefficients 910 of the neural network.

Meanwhile, the CPU 403 executes the online learning task 905. In this way, the CPU 403 updates the second coefficients 908 using the second features 907 generated by the CNN processing unit 401. The updated second coefficients 908 are used when the CNN processing unit 401 executes the neural network computation with respect to the next frame.

In the foregoing task configuration, the second features 907 are referred to by both of the CNN processing unit 401 and the CPU 403. A description will be provided to show that, even in such a case, the parallel execution of the online learning task by the CPU 403 is possible during the execution of the neural network task by the CNN processing unit 401.

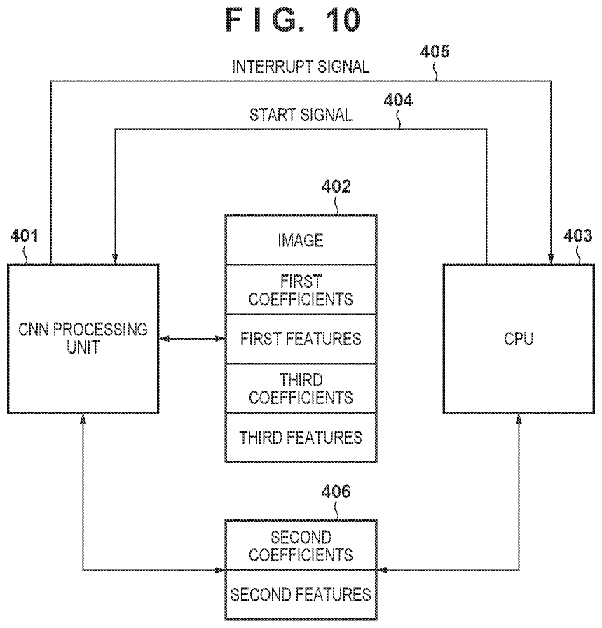

Next, data stored in the memory 402 and the memory 406 will be described using FIG. 10. Similarly to the first embodiment, data that is shared by the neural network task and the online learning task (the second coefficients 908 and the second features 907) are stored in the memory 406. On the other hand, data that is used only by the CNN processing unit 401 (the image 901, the first coefficients 904, the first features 903, the third coefficients 910, and the third features 909) is stored in the memory 402.

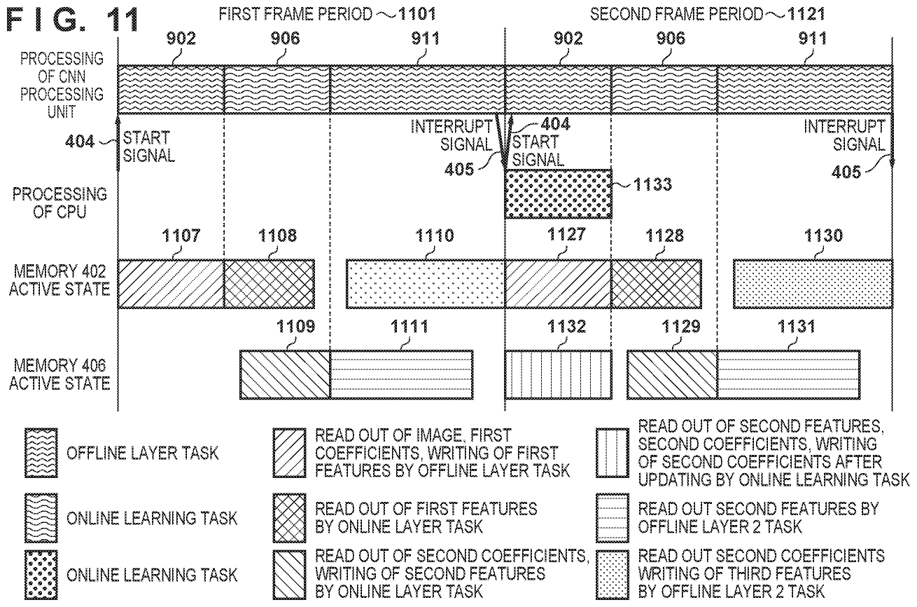

The neural network task and the online learning task that are executed by the computation apparatus according to the present embodiment in accordance with the foregoing configuration will be described using FIG. 11. FIG. 11 shows operation statuses of the CNN processing unit 401, the CPU 403, the memory 402, and the memory 406 during a processing period for a first frame (a first frame period 1101), and operation statuses of the CNN processing unit 401, the CPU 403, the memory 402, and the memory 406 during a processing period for a second frame (a second frame period 1121).

The CPU 403 notifies the CNN processing unit 401 of a start signal 404 at a timing to start processing with respect to the first frame, such as a timing at which the first frame has been input.

Upon detecting the start signal 404, the CNN processing unit 401 executes an offline layer task 902. In the execution of the offline layer task 902, the CNN processing unit 401 first reads out the image 901 (first frame) and the first coefficients 904 from the memory 402. Then, the CNN processing unit 401 generates the first features 903 of the first frame by executing the neural network computation with use of the first frame and the first coefficients 904, and stores the first features 903 of the first frame into the memory 402. An active state 1107 of the memory 402 indicates a period of access to the memory 402 for readout of the first frame and the first coefficients 904 from the memory 402, and for storing of the first features 903 of the first frame into the memory 402.

Upon completion of the offline layer task 902, the CNN processing unit 401 subsequently executes an online layer task 906. In the execution of the online layer task 906, the CNN processing unit 401 reads out the first features 903 of the first frame, which have been stored into the memory 402 in the offline layer task 902, from the memory 402, and also reads out the second coefficients 908 from the memory 406. Then, the CNN processing unit 401 generates the second features 907 of the first frame by executing the neural network computation with use of the first features 903 and the second coefficients 908, and stores the second features 907 of the first frame into the memory 406. An active state 1108 of the memory 402 indicates a period of access to the memory 402 for readout of the first features 903 from the memory 402. An active state 1109 of the memory 406 indicates a period of access to the memory 406 for readout of the second coefficients 908 from the memory 406, and for storing of the second features 907 of the first frame into the memory 406.

Upon completion of the online layer task 906, the CNN processing unit 401 executes an offline layer task 911. In the execution of the offline layer task 911, the CNN processing unit 401 reads out the second features 907 of the first frame from the memory 406, and also reads out the third coefficients 910 from the memory 402. Then, the CNN processing unit 401 generates the third features 909 of the first frame by executing the neural network computation with use of the second features 907 of the first frame and the third coefficients 910, and stores the third features 909 of the first frame into the memory 402. An active state 1110 of the memory 402 indicates a period of access to the memory 402 for readout of the third coefficients 910 from the memory 402, and for storing of the third features 909 into the memory 402. An active state 1111 of the memory 406 indicates a period of access to the memory 406 for readout of the second features 907 of the first frame from the memory 406. Upon completion of the online layer task 911, the CNN processing unit 401 notifies the CPU 403 of an interrupt signal 405.

Upon receiving the aforementioned interrupt signal 405 from the CNN processing unit 401, the CPU 403 executes an online learning task 1133. At this point, the second coefficients 908 and the second features 907 of the first frame are stored in the memory 406. Therefore, in the execution of the online learning task 1133, the CPU 403 reads out the second coefficients 908 and the second features 907 of the first frame from the memory 406, and updates the second coefficients 908 using the second features 907 of the first frame. Then, the CPU 403 stores the updated second coefficients 908 by overwriting the second coefficients stored in the memory 406 using the same.

Also, upon receiving the aforementioned interrupt signal 405 from the CNN processing unit 401, the CPU 403 notifies the CNN processing unit 401 of a start signal 404. Upon detecting the start signal 404 from the CPU 403, the CNN processing unit 401 executes an offline layer task 902. The offline layer task 902 is a task similar to the above-described offline layer task 502; through the execution of the offline layer task 902, the CNN processing unit 401 generates the first features 903 of the second frame, and stores the first features 903 of the second frame into the memory 402. That is to say, in the present embodiment, the online learning task 1133 of the CPU 403 and the offline layer task 902 of the CNN processing unit 401 are executed in parallel.

An active state 1127 of the memory 402 indicates a period of access to the memory 402 for readout of the second frame and the first coefficients 904 from the memory 402, and for storing of the first features 903 into the memory 402.

An active state 1132 of the memory 406 indicates a period of access to the memory 406 for readout of the second coefficients 908 and the second features 907 of the first frame from the memory 406, and for storing of the second coefficients 908 into the memory 406.

Upon completion of the offline layer task 902, the CNN processing unit 401 subsequently executes an online layer task 906. In the execution of the online layer task 906, the CNN processing unit 401 reads out the first features 903, which have been stored into the memory 402 in the offline layer task 902, from the memory 402, and also reads out the second coefficients 908 updated through the online learning task 1133 from the memory 406. Then, the CNN processing unit 401 generates the second features 907 of the second frame by executing the neural network computation with use of the first features 903 and the second coefficients 908 that have been read out, and stores the second features 907 of the second frame into the memory 406.

An active state 1128 of the memory 402 indicates a period of access to the memory 402 for readout of the first features 903 from the memory 402. An active state 1129 of the memory 406 indicates a period of access to the memory 406 for readout of the second coefficients 908 from the memory 406, and for storing of the second features 907 of the second frame into the memory 406.

Upon completion of the online layer task 906, the CNN processing unit 401 subsequently executes an offline layer task 911. In the execution of the offline layer task 911, the CNN processing unit 401 reads out the second features 907, which have been stored into the memory 406 in the online layer task 906, from the memory 406, and also reads out the third coefficients 910 from the memory 402. Then, the CNN processing unit 401 generates the third features 909 of the second frame by executing the neural network computation with use of the second features 907 and the third coefficients 910 that have been read out, and stores the third features 909 of the second frame into the memory 402.

An active state 1130 of the memory 402 indicates a period of access to the memory 402 for readout of the third coefficients 910 from the memory 402, and for storing of the third features 909 into the memory 402. An active state 1131 of the memory 406 indicates a period of access to the memory 406 for readout of the second features 907 from the memory 406. Upon completion of the offline layer task 911, the CNN processing unit 401 notifies the CPU 403 of an interrupt signal 405.

During a period in which the offline layer task 902 and the online learning task 1133 are executed in parallel, the CNN processing unit 401 accesses the memory 402, and the CPU 403 accesses the memory 406. Therefore, a memory access conflict between the CNN processing unit 401 and the CPU 403 is suppressed, and the parallel execution of an online learning task by the CPU 403 becomes possible while suppressing a decline in the performance caused by a wait for a memory access by the CNN processing unit 401.

The present embodiment has described that a neural network task, in which an online layer task is arranged between two offline layer tasks, and an online learning task can be executed in parallel.

### Third Embodiment

In the present embodiment, the differences from the second embodiment will be described, and it is assumed that the present embodiment is similar to the second embodiment unless specifically stated otherwise below. The present embodiment will be described with regard to a case where an online learning task is executed during the execution of an offline layer task, which is different from the second embodiment.

In the second embodiment, second coefficients used in an online layer task 906 are updated through an online learning task 1133 that is executed in parallel with an offline layer task 902.

In contrast, in the present embodiment, second coefficients used in an online layer task 906 are updated through an online learning task that is executed in parallel with an offline layer task 911 according to the example of FIG. 11.

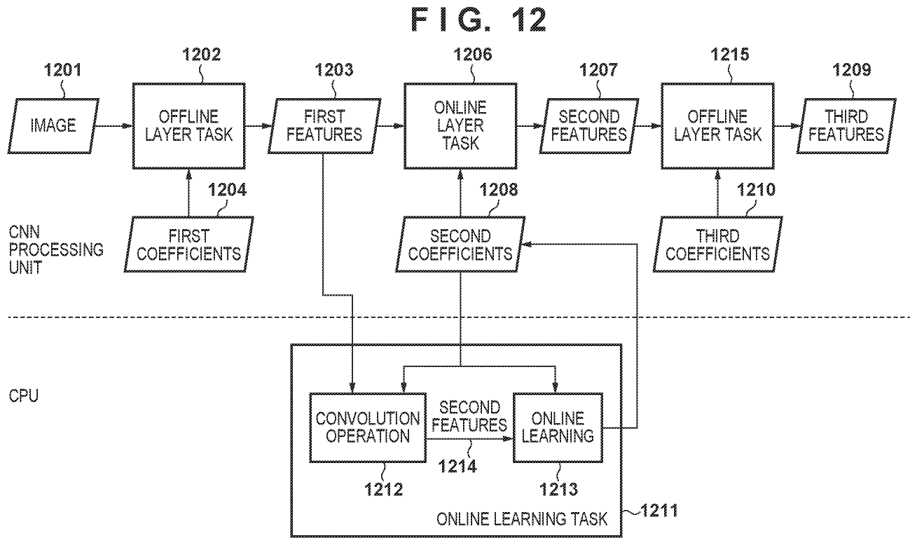

In order to execute an online learning task and an offline layer task in parallel, it is necessary to solve a conflict of accesses to the second features that are used by both of the offline layer task and the online learning task. The structures of processing executed by the CNN processing unit 401 and the CPU 403 according to the present embodiment will be described using a block diagram of FIG. 12.

A neural network task executed by the CNN processing unit 401 is divided into an offline layer task 1202, an online layer task 1206, and an offline layer task 1215, which are executed in this order.

Meanwhile, the CPU 403 executes an online learning task 1211. In this way, the CPU 403 updates the second coefficients 908 using first features 1203 generated by the CNN processing unit 401. The online learning task 1211 includes a convolution operation 1212 and online learning 1213.

In the convolution operation 1212, second features 1214 are obtained by executing processing that is equivalent to the online layer task 1206 with use of the first features 1203 and second coefficients 1208. In the online learning 1213, the second coefficients 1208 are updated by executing processing similar to the online learning task according to the second embodiment with use of the second coefficients 1208 and the second features 1214.

In the present embodiment, a memory access conflict is suppressed by generating data used by both of the CNN processing unit 401 and the CPU 403 in each of these processing units; as a result, the neural network task and the online learning task can be executed in parallel.

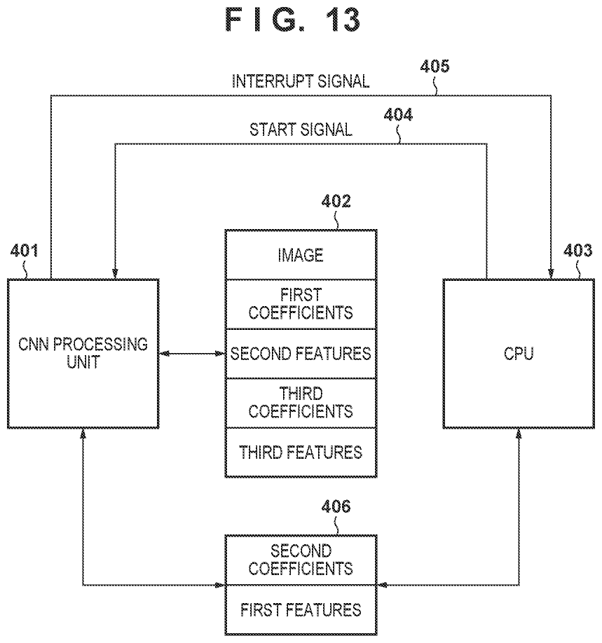

Next, data stored in the memory 402 and the memory 406 will be described using FIG. 13. Data that is shared by the neural network task and the online learning task (the second coefficients 1208 and the first features 1203) are stored in the memory 406. On the other hand, data that is used only by the CNN processing unit 401 (the image 1201, the first coefficients 1204, the second features 1207, the third coefficients 1210, and the third features 1209) is stored in the memory 402.

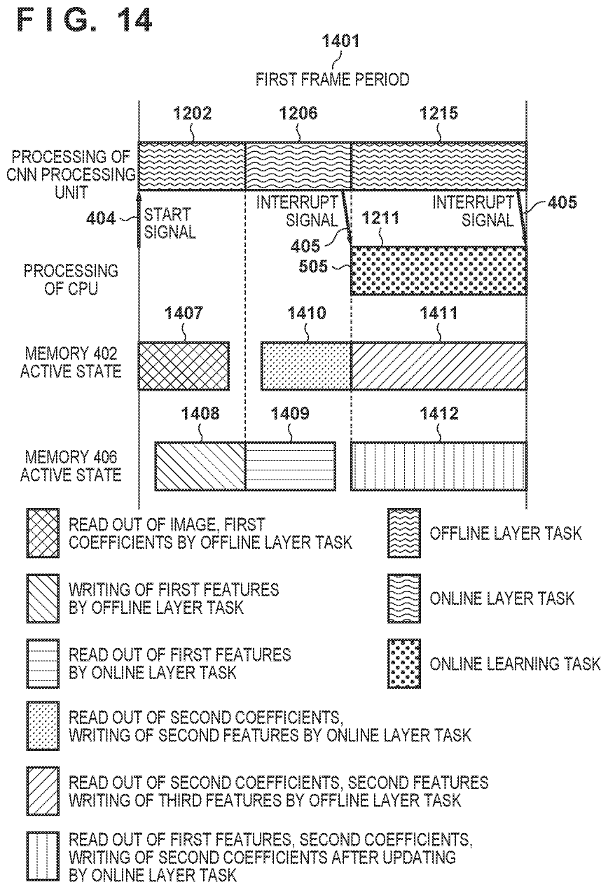

The neural network task and the online learning task that are executed by the computation apparatus according to the present embodiment in accordance with the foregoing configuration will be described using FIG. 14. FIG. 14 shows operation statuses of the CNN processing unit 401, the CPU 403, the memory 402, and the memory 406 during a processing period for a first frame (a first frame period 1401). Note that in the present embodiment, the operation statuses of the CNN processing unit 401, the CPU 403, the memory 402, and the memory 406 are similar also with respect to each of the frames that succeed the first frame.

The CPU 403 notifies the CNN processing unit 401 of a start signal 404 at a timing to start processing with respect to the first frame, such as a timing at which the first frame has been input.

Upon detecting the start signal 404, the CNN processing unit 401 executes an offline layer task 1202. In the execution of the offline layer task 1202, the CNN processing unit 401 first reads out the image 1201 (first frame) and the first coefficients 1204 of the neural network, which are not updated through the online learning task 1211, from the memory 402. Then, the CNN processing unit 401 generates the first features 1203 of the first frame by executing the neural network computation with use of the first frame and the first coefficients 1204, and stores the first features 1203 of the first frame into the memory 406. An active state 1407 of the memory 402 indicates a period of access to the memory 402 for readout of the first frame and the first coefficients 1204 from the memory 402. An active state 1408 of the memory 406 indicates a period of access to the memory 406 for storing of the first features 1203 into the memory 406.

Upon completion of the offline layer task 1202, the CNN processing unit 401 subsequently executes an online layer task 1206. In the execution of the online layer task 1206, the CNN processing unit 401 reads out the first features 1203 of the first frame, which have been stored into the memory 406 through the offline layer task 1202, and the second coefficients 1208, which are updated through the online learning task 1211, from the memory 406. Then, the CNN processing unit 401 generates the second features 1207 of the first frame by executing the neural network computation with use of the first features 1203 of the first frame and the second coefficients 1208, and stores the second features 1207 into the memory 402. An active state 1410 of the memory 402 indicates a period of access to the memory 402 for storing of the second features 1207 into the memory 402. An active state 1409 of the memory 406 indicates a period of access to the memory 406 for readout of the first features 1203 and the second coefficients 1208 from the memory 406.

Upon completion of the online layer task 1206, the CNN processing unit 401 notifies the CPU 403 of an interrupt signal 405. Upon detecting the interrupt signal 405, the CPU 403 executes the online learning task 1211. In the execution of the online learning task 1211, the CPU 403 reads out the second coefficients 1208 and the first features 1203 of the first frame from the memory 406. Then, the CPU 403 obtains the second features 1214 by executing processing that is equivalent to the online layer task 1206 with use of the first features 1203 of the first frame and the second coefficients 1208. Then, the CPU 403 updates the second coefficients 1208 by executing processing similar to the online learning task according to the second embodiment with use of the second coefficients 1208 and the second features 1214. Then, the CPU 403 stores the updated second coefficients 1208 by overwriting the second coefficients 1208 stored in the memory 406 using the same.

Furthermore, upon completion of the online layer task 1206, the CNN processing unit 401 executes an offline layer task 1215. In the execution of the offline layer task 1215, the CNN processing unit 401 reads out the second features 1207 of the first frame from the memory 402, and also reads out the third coefficients 1210 from the memory 402. Then, the CNN processing unit 401 generates the third features 1209 of the first frame by executing the neural network computation with use of the second features 1207 of the first frame and the third coefficients 1210, and stores the third features 1209 of the first frame into the memory 402. An active state 1411 of the memory 402 indicates a period of access to the memory 402 for readout of the second features 1207 and the third coefficients 1210 from the memory 402, and for storing of the third features 1209 into the memory 402. An active state 1412 of the memory 406 indicates a period of access to the memory 406 for readout of the second coefficients 1208 and the first features 1203 from the memory 406, and for storing of the second coefficients 1208 into the memory 406. Upon completion of the offline layer task 1215, the CNN processing unit 401 notifies the CPU 403 of an interrupt signal 405. That is to say, in the present embodiment, the online learning task 1211 of the CPU 403 and the offline layer task 1215 of the CNN processing unit 401 are executed in parallel.

During a period in which the offline layer task 1215 and the online learning task 1211 are executed in parallel, the CNN processing unit 401 accesses the memory 402, and the CPU 403 accesses the memory 406. Therefore, a memory access conflict between the CNN processing unit 401 and the CPU 403 is suppressed, and the parallel execution of an online learning task by the CPU 403 becomes possible while suppressing a decline in the performance caused by a wait for a memory access by the CNN processing unit 401.

The present embodiment has shown that, even in a case where there is data that is used by both of the online learning task and the neural network task that operates in parallel with the online learning task, a memory access conflict is suppressed and the parallel execution is enabled as a result of the CPU generating such data separately.

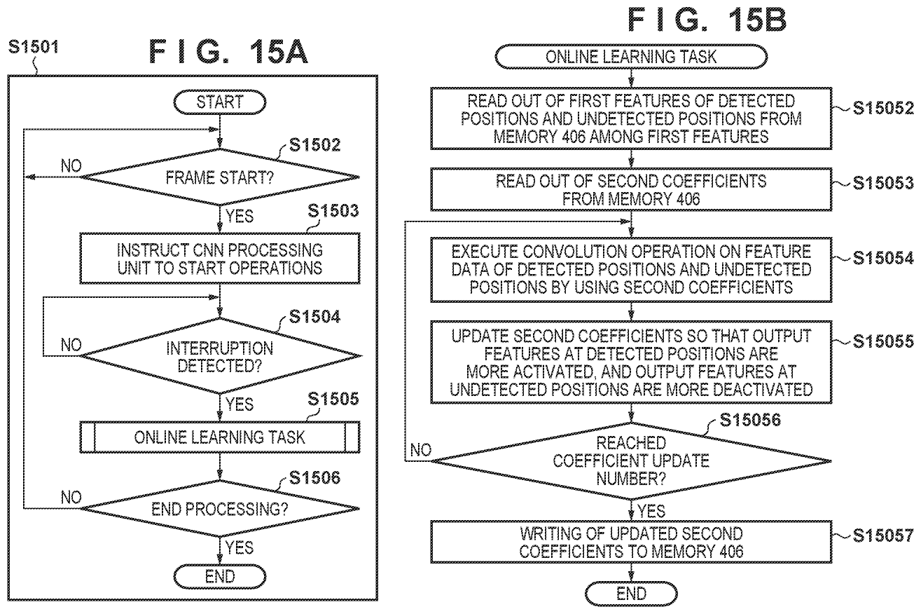

The operations of the CPU 403 are now described in line with the flowcharts of FIGS. 15A and 15B. First, step S1501, which represents processing steps of main processing of the CPU 403, will be described in line with the flowchart of FIG. 15A.

In step S1502, the CPU 403 determines whether a frame start condition has been satisfied, similarly to the above-described step S802. In a case where the frame start condition has been satisfied as a result of this determination, processing proceeds to step S1503; in a case where the frame start condition has not been satisfied, processing stands by in step S1502.

In step S1503, in order to instruct the CNN processing unit 401 to start the operations, the CPU 403 notifies the CNN processing unit 401 of a start signal. Upon detecting the start signal, the CNN processing unit 401 executes an offline layer task and an online layer task as described above.

In step S1504, the CPU 403 determines whether an interrupt signal from the CNN processing unit 401 has been detected. In a case where the interrupt signal from the CNN processing unit 401 has been detected as a result of this determination, processing proceeds to step S1505; in a case where the interrupt signal from the CNN processing unit 401 has not been detected, processing stands by in step S1504.

In step S1505, the CPU 403 executes an online learning task. The details of step S1505 will be described later. In step S1506, the CPU 403 determines whether a condition for ending the main processing has been satisfied, similarly to the above-described step S807. In a case where the condition for ending the main processing has been satisfied as a result of this determination, processing of step S1501 is ended; in a case where the condition for ending the main processing has not been satisfied, processing proceeds to step S1502.

Next, the details of processing in the aforementioned step S1505 will be described in line with the flowchart of FIG. 15B. In step S15052, the CPU 403 reads out, from among the first features 1203 stored in the memory 406, the first features 1203 at detected positions of a detection target and the first features 1203 at undetected positions of the detection target. Then, in step S15053, the CPU 403 reads out the second coefficients 1208 from the memory 406.

In step S15054, the CPU 403 obtains the second features 1214 (the output features at detected positions of the detection target and the output features at undetected positions) by executing processing that is equivalent to the online layer task 1206 with use of the first features 1203 and the second coefficients 1208.

In step S15055, the CPU 403 updates the second coefficients 1208 by executing processing similar to the online learning task according to the second embodiment with use of the second coefficients 1208 and the second features 1214. The CPU 403 updates the second coefficients 1208 so that the second features 1214 at detected positions of the detection target are more activated, and the second features 1214 at undetected positions are more deactivated.

In step S15056, the CPU 403 determines whether the number of times the second coefficients 1208 have been updated has become equal to or larger than a threshold. The threshold may be a value that has been determined in advance, or may be a value that has been dynamically determined.

In a case where the number of times the second coefficients 1208 have been updated has become equal to or larger than the threshold as a result of this determination, processing proceeds to step S15057; in a case where the number of times the second coefficients 1208 have been updated is smaller than the threshold, processing proceeds to step S15054. In step S15057, the CPU 403 stores the second coefficients 1208 that have been updated through the foregoing processing by overwriting the second coefficients 1208 stored in the memory 406 using the same.

### Fourth Embodiment

Even in a mode in which a plurality of online layer tasks exist, neural network computation and online learning can be executed in parallel by storing data used in the online layer task into the memory 406 similarly to the above-described embodiments.

Also, although the above embodiments have been described using an example of recognition processing executed by the CNN, no limitation is intended by this, and various recognition algorithms may be used. For example, recognition algorithms based on a multilayer perceptron, a transformer, or the like other than the CNN may be used. In addition, the above-described embodiments are also applicable to learning with respect to a final layer of a random network such as an echo state network and an extreme learning machine.

Furthermore, the memory 402 and the memory 406 may be composed of a plurality of memories. For example, an image, coefficients, and features may be respectively stored into independent memories, and the respective memories may be accessed in parallel.

Also, the above embodiments have been described in relation to a case where the convolution operation is processed by hardware. However, the convolution operation may be realized as a result of execution of a computer program by a processor such as a CPU, a graphics processing unit (GPU), and a digital signal processing unit (DSP).

Furthermore, the computation apparatus described in the above embodiments may be an embedded device embedded in an apparatus that processes and outputs an input image (an apparatus such as a digital camera, a smartphone, and a tablet terminal apparatus). As described above, the computation apparatus described in the above embodiments executes neural network computation and online learning in parallel, thereby enabling a reduction in a processing time period required for each frame compared to the above-described conventional technique. Therefore, according to the computation apparatus described in the above embodiments, there is no need to increase the operation frequency of the computation apparatus to suppress a reduction in the frame rate.

Numerical values, processing timings, the order of processing, the executors of processing, the obtainment method/transmission destination/transmission source/storage locations of data (information), and the like used in each of the above-described embodiments have been shown as examples for the purpose of providing specific explanations, and are not intended to be limiting examples.

In addition, parts or all of the above-described embodiments may be used in combination as appropriate. Furthermore, a part or all of the above-described embodiments may be selectively used.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-091032, filed Jun. 1, 2023, which is hereby incorporated by reference herein in its entirety.

What is claimed is:

1. A computation apparatus, comprising:
a first processing unit configured to obtain a first feature by executing computation of a neural network with use of a first coefficient that is not to be updated in online learning of the neural network;
a second processing unit configured to obtain a second feature by executing the computation of the neural network with use of the first feature and a second coefficient that is to be updated in the online learning; and
an update unit configured to update the second coefficient by executing the online learning with use of the second coefficient and a second feature that has been obtained by the second processing unit in a past,
wherein processing of the first processing unit and processing of the update unit are executed in parallel.

2. The computation apparatus according to claim 1, wherein
the first processing unit obtains a first feature of a frame with use of the frame and the first coefficient, and
the second processing unit obtains a second feature of the frame with use of the first feature of the frame and the second coefficient.

3. The computation apparatus according to claim 2, wherein
the first processing unit obtains a first feature of a second frame,
the update unit updates the second coefficient by executing the online learning with use of the second coefficient and a second feature of a first frame that has been input earlier than the second frame, and
the second processing unit obtains a second feature of the second frame with use of the first feature of the second frame and the second coefficient updated by the update unit.

4. The computation apparatus according to claim 1, further comprising:
a first memory configured to hold the first coefficient; and
a second memory configured to hold the second coefficient,
wherein
the first processing unit stores the first feature into the first memory, and
the second processing unit stores the second feature into the second memory.

5. The computation apparatus according to claim 1, further comprising:
a third processing unit configured to obtain a third feature by executing the computation of the neural network with use of the second feature and a third coefficient of the neural network.

6. A computation apparatus, comprising:
a first processing unit configured to obtain a first feature by executing computation of a neural network with use of a first coefficient that is not to be updated in online learning of the neural network;
a second processing unit configured to obtain a second feature by executing the computation of the neural network with use of the first feature and a second coefficient that is to be updated in the online learning;
a third processing unit configured to obtain a third feature by executing the computation of the neural network with use of the second feature and a third coefficient of the neural network; and
an update unit configured to update the second coefficient by executing the online learning based on the second coefficient and the first feature,
wherein processing of the third processing unit and processing of the update unit are executed in parallel.

7. The computation apparatus according to claim 6, wherein
the update unit updates the second coefficient with use of the second coefficient and a feature that is obtained by executing computation equivalent to the computation that is executed by the second processing unit with use of the second coefficient and the first feature.

8. The computation apparatus according to claim 1, wherein
the computation apparatus is an embedded device.

9. A computation method implemented by a computation apparatus, comprising:
obtaining a first feature by executing computation of a neural network with use of a first coefficient that is not to be updated in online learning of the neural network;
obtaining a second feature by executing the computation of the neural network with use of the first feature and a second coefficient that is to be updated in the online learning; and
updating the second coefficient by executing the online learning with use of the second coefficient and a second feature that has been obtained in a past,
wherein the obtainment of the first feature and the updating are executed in parallel.

10. A computation method implemented by a computation apparatus, comprising:
obtaining a first feature by executing computation of a neural network with use of a first coefficient that is not to be updated in online learning of the neural network;
obtaining a second feature by executing the computation of the neural network with use of the first feature and a second coefficient that is to be updated in the online learning;
obtaining a third feature by executing the computation of the neural network with use of the second feature and a third coefficient of the neural network; and
updating the second coefficient by executing the online learning based on the second coefficient and the first feature,
wherein the obtainment of the third feature and the updating are executed in parallel.

11. A non-transitory computer-readable storage medium storing a computer program that causes a computer to function as:
a first processing unit configured to obtain a first feature by executing computation of a neural network with use of a first coefficient that is not to be updated in online learning of the neural network;
a second processing unit configured to obtain a second feature by executing the computation of the neural network with use of the first feature and a second coefficient that is to be updated in the online learning; and
an update unit configured to update the second coefficient by executing the online learning with use of the second coefficient and a second feature that has been obtained by the second processing unit in a past,
wherein processing of the first processing unit and processing of the update unit are executed in parallel.

12. A non-transitory computer-readable storage medium storing a computer program that causes a computer to function as:
a first processing unit configured to obtain a first feature by executing computation of a neural network with use of a first coefficient that is not to be updated in online learning of the neural network;
a second processing unit configured to obtain a second feature by executing the computation of the neural network with use of the first feature and a second coefficient that is to be updated in the online learning;
a third processing unit configured to obtain a third feature by executing the computation of the neural network with use of the second feature and a third coefficient of the neural network; and
an update unit configured to update the second coefficient by executing the online learning based on the second coefficient and the first feature,
wherein the obtainment of the third feature and the updating are executed in parallel.
